(19) United States
(12) Patent Application Publication
(10) Pub. No.: US 2025/0223990 A1
(43) Pub. Date: Jul. 10, 2025

(54) JOINING METHOD UTILIZING A PIERCED FEATURE FOR CREATING A CRUSHABLE SEAL AND ROTATION LOCK FOR A RIVET CONNECTION

(71) Applicant: Schaeffler Technologies AG & Co. KG, Herzogenaurach (DE)

(72) Inventor: Trent Hendershot, Wooster, OH (US)

(73) Assignee: Schaeffler Technologies AG & Co. KG, Herzogenaurach (DE)

(21) Appl. No.: 18/408,762

(22) Filed: Jan. 10, 2024

(51) Int. Cl. F16B 19/04

(52) U.S. Cl. CPC F16B 19/04

(57) ABSTRACT

A method of joining a first and second workpiece including forming a first bore in a first workpiece and an annular ridge surrounding the first bore, forming a second bore in a second workpiece and an annular recess surrounding the second bore, placing the first workpiece in contact with the second workpiece such that the annular ridge is received in the annular recess, and forming a hermetic seal between the first and second workpieces by deforming the annular ridge within the annular recess through application of compressive force to at least one of the first or second workpieces.

### TECHNICAL FIELD

The present disclosure relates generally to rivet connections, and more specifically to a rivet connections between a rotor and cover of a torque converter.

### BACKGROUND

Torque converter assemblies generally include a front cover and a pump cover enclosing internal components, such as a lock-up clutch. Connections between the various components of a torque converter assembly can be complicated, and require significant labor costs and assembly time. Such connections can include welds and rivets, for example.

Rivets for connecting two or more components are well-known. In general, a rivet typically includes a head and a shank. The shank is received in bores of the components to be joined, and a tail end of the shank is deformed such that the rivet cannot be removed from the bores.

In applications where rivets connections are used between components containing fluids, such as in a torque converter, leakage can occur along the rivet.

### SUMMARY

In accordance with one aspect of the present disclosure, a method of joining a first and second workpiece comprises forming a first bore in a first workpiece, the first bore extending between a first side of the first workpiece and a second side of the first workpiece, forming an annular ridge surrounding the first bore on at least one of the first or second sides of the first workpiece, forming a second bore in a second workpiece, forming an annular recess surrounding the second bore, placing the first workpiece in contact with the second workpiece such that the annular ridge is received in the annular recess, and forming a hermetic seal between the first and second workpieces by deforming the annular ridge within the annular recess through application of compressive force to at least one of the first or second workpieces.

The second bore can extend between first and second sides of the second workpiece. The method can include inserting a fastener through the first and second bores. The fastener can includes a rivet, and deforming the annular ridge can be performed during installation of the rivet. The annular ridge, prior to deformation, can comprise an apex and the annular recess can comprise a planar surface. The apex of the annular ridge can be flattened against the planar surface of the annular recess after deformation. The first bore and the annular ridge can be formed in a piercing process. The first bore and the annular ridge can formed in a single processing step.

The first workpiece can include a housing of a pressurized chamber of a torque converter. The first and second bores can be adapted to receive a rotating component of the torque converter. The annular ridge can protrude from a planar main portion of the first workpiece between approximately 0.5 mm to 1.5 mm, for example.

In accordance with another aspect, an assembly comprises a first workpiece having a first bore extending between a first side of the first workpiece and a second side of the first workpiece, and an annular ridge surrounding the first bore on at least one of the first or second sides of the first workpiece, and a second workpiece having a second bore and an annular recess surrounding the second bore. The first workpiece and the second workpiece are arranged such that the annular ridge is received in the annular recess, and the annular ridge is deformed within the annular recess such that at least a portion of the annular ridge has a shape corresponding to the annular recess thereby forming a hermetic seal between the first and second workpieces.

The second bore can extend between first and second sides of the second workpiece. The assembly can further include a fastener inserted through the first and second bores. The fastener can include a rivet, and the annular ridge can be deformed during installation of the rivet. The first workpiece can include a housing of a pressurized chamber of a torque converter. The first and second bores can be adapted to receive a rotating component of the torque converter.

Additional embodiments are disclosed herein.

### BRIEF DESCRIPTION OF THE DRAWINGS

The foregoing Summary and the following Detailed Description will be better understood when read in conjunction with the appended drawings, which illustrate a preferred embodiment of the disclosure. In the drawings:

FIG. 1 is a cross-sectional view of a prior art rivet assembly.

FIG. 2 is a cross-sectional view of an exemplary first workpiece in accordance with aspects of the present disclosure.

FIG. 3 is a cross-sectional view of the first workpiece of FIG. 2 and an exemplary second workpiece in accordance with the present disclosure prior to being joined together.

FIG. 4 is a cross-sectional view of the components of FIG. 3 after being joined together.

FIG. 5 is an enlarged portion of FIG. 4.

FIG. 6 is a cross-sectional view of a portion of a torque converter assembly in accordance with the present disclosure.

FIG. 7 is an enlarged portion of FIG. 6.

FIG. 8 is a enlarged cross-sectional view of a ridge/recess interface of the torque converter assembly of FIG. 6.

### DETAILED DESCRIPTION

Certain terminology is used in the following description for convenience only and is not limiting. The words “front,” “rear,” “upper” and “lower” designate directions in the drawings to which reference is made. The words “inwardly” and “outwardly” refer to directions toward and away from the parts referenced in the drawings. “Axially” refers to a direction along the axis of a shaft. A reference to a list of items that are cited as “at least one of a, b, or c” (where a, b, and c represent the items being listed) means any single one of the items a, b, or c, or combinations thereof. The terminology includes the words specifically noted above, derivatives thereof and words of similar import.

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

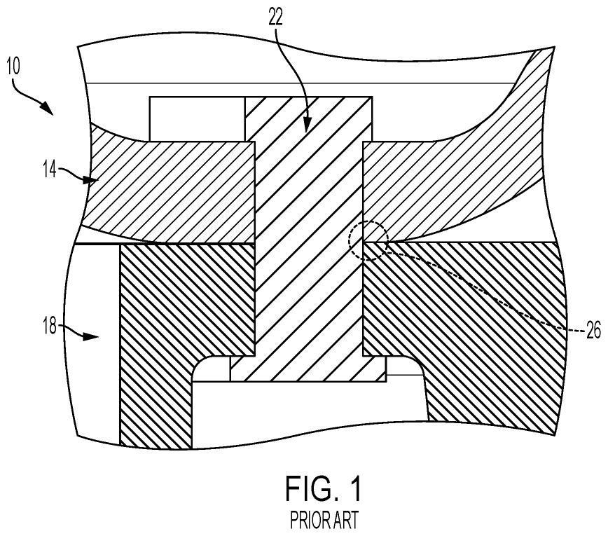

Referring to FIG. 1, a conventional riveted assembly is illustrated and identified generally by reference numeral 10. The assembly includes a first workpiece 14, a second workpiece 18, and a rivet 22 extending through bores in the respective workpieces 14 and 18. The rivet 22 secured the workpieces 14 and 18 together, however, in pressurized applications leakage can occur between the workpieces 14 and 18 in the region identified by reference numeral 26, for example.

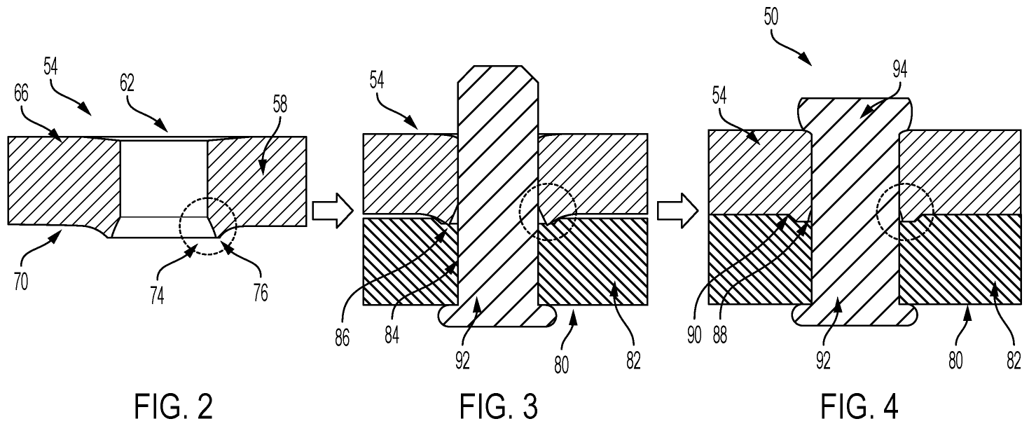

Turning to FIGS. 2-5, an assembly in accordance with the present disclosure is illustrated and identified generally by reference numeral 50. It will be appreciated that FIGS. 2-4 illustrate the various components of the assembly 50 at different stages of construction of the assembly 50 shown in FIG. 5.

In FIG. 2, a first workpiece 54 of the assembly 50 includes a main body 58 having a bore 62 extending from a first side 66 to a second side 70 of the main body 58. The main body 58 is generally planar in the region surrounding the bore 62. An annular ridge 74 surrounds the bore 62. The annular ridge includes an apex 76 terminating in a point, although other ridge geometries can be used.

In FIG. 3, a second workpiece 80 of the assembly 50 includes a main body 82 having a bore 84. An annular recess 86 surrounds the bore 84. The first workpiece 54 and the second workpiece 80 are arranged such that the bores 62 and 84 are aligned and the annular ridge 74 of the first workpiece 54 is received in the annular recess 84. The annular recess 84 generally has a flat radially extending annular surface 88 extending perpendicularly to an axis of the bore 84 and an angled sidewall 90. A fastener in the form of a rivet 92 is installed through the bores 62 and 84.

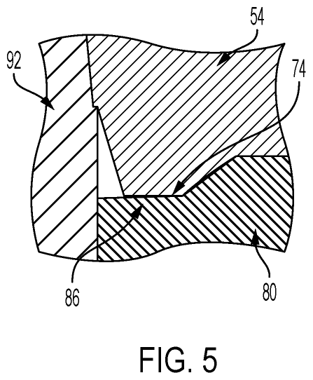

In FIGS. 4 and 5, the assembly 50 is shown in a completed state with a tail 94 of the rivet 92 deformed. It will be appreciated that during installation of the rivet 92 a compressive force is applied to force the workpieces 54 and 80 together thereby also deforming the annular ridge 74 in the annular recess 86. At least a portion of the deformed annular ridge 74 takes on the shape of the annular recess 86 thereby forming a hermetic seal between the workpieces 54 and 80. The hermetic seal can maintain pressures of, for example, 5 bar or greater.

Aspects of the present disclosure provide a hermetic seal between mating workpieces that is formed without extra processing steps. For example, the annular ridge 74 and annular recess 86 can be formed as part of existing process steps for piercing the respective workpieces. Crushing or deformation of the annular ridge 74 into the annular recess 86 can be carried out as part of an existing riveting process. In addition to these benefits, the annular ridge 74 and annular recess 86 rotationally interlock the workpieces when the work pieces are positioned for assembly prior to inserting the faster. This can aid in assembly.

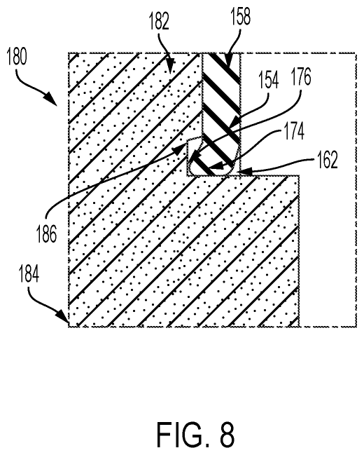

Turning to FIGS. 6-8, aspects of the present disclosure are embodied in a torque converter assembly 100 for hermetically sealing a pressurized portion from an unpressurized portion of the torque converter assembly.

FIG. 6 illustrates a portion of a torque converter assembly 100 that includes a variety of components (e.g., a pump, clutch, etc.). As torque converters are well-known, additional details of the torque converter assembly 100 are not further described herein except as necessary to understand the present embodiment. Aspects of the present disclosure are shown in this embodiment sealing a connection between a torque converter cover and a rotor carrier of the torque converter 100.

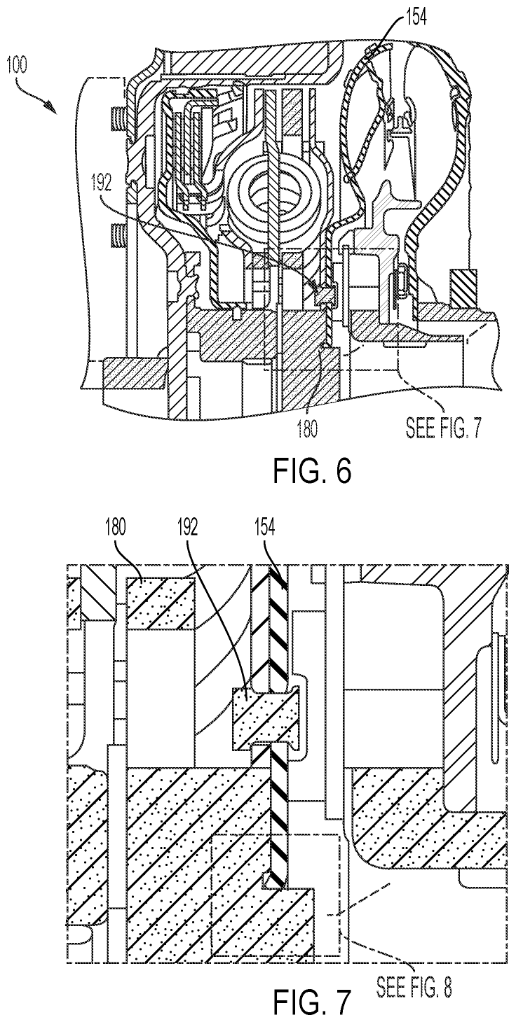

In FIG. 7, an interface of the torque converter cover and a rotor carrier of the torque converter 100 is shown in detail. The torque converter cover constitutes a first workpiece identified by reference numeral 154 and includes a main body 158 having a bore 162 extending therethrough. An annular ridge 174 surrounds the bore 162. The annular ridge includes an apex 176 terminating in a point, although other ridge geometries can be used.

The rotor carrier constitutes a second workpiece identified by reference numeral 180 and includes a main body 182 having a bore 184. An annular recess 186 surrounds the bore 184. In this embodiment, the annular recess 186 is spaced radially from the bore 184. The first workpiece 154 and second workpiece 180 are arranged such that the bores 162 and 184 are aligned and the annular ridge 174 of the first workpiece 154 is received in the annular recess 184.

In this embodiment, the first and second workpieces 154 and 180 are secured together by a plurality of rivets 192 spaced circumferentially about the bores 162 and 184. The bores 182 and 184 are configured to receive a rotating component therethrough, for example, a turbine shell and hub (not shown). During installation of the rivets 192, the workpieces 154 and 180 are compressed together deforming the annular ridge 174 into the annular recess 186 in the same manner described above in connection with FIGS. 2-5 thereby forming a hermetic seal.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

Having thus described the present embodiments in detail, it is to be appreciated and will be apparent to those skilled in the art that many physical changes, only a few of which are exemplified in the detailed description of the disclosure, could be made without altering the inventive concepts and principles embodied therein.

It is also to be appreciated that numerous embodiments incorporating only part of the preferred embodiment are possible which do not alter, with respect to those parts, the inventive concepts and principles embodied therein.

The present embodiment and optional configurations are therefore to be considered in all respects as exemplary and/or illustrative and not restrictive, the scope of the disclosure being indicated by the appended claims rather than by the foregoing description, and all alternate embodiments and changes to this embodiment which come within the meaning and range of equivalency of said claims are therefore to be embraced therein.

### LOG OF REFERENCE NUMERALS

10 riveted assembly
14 first workpiece
18 second workpiece
22 rivet
26 region
50 assembly
54 first workpiece
58 main body
62 bore
66 first side
70 second side
74 annular ridge
76 apex
80 second workpiece
82 main body
84 bore
86 annular recess
88 annular surface
90 sidewall
92 rivet
94 tail
100 torque converter assembly
154 first workpiece/torque converter cover
158 main body
162 bore
174 annular ridge
176 apex
180 second workpiece/rotor carrier
182 main body
184 bore
186 annular recess
192 rivets

What is claimed is:

1. A method of joining a first and second workpiece, comprising:
forming a first bore in a first workpiece, the first bore extending between a first side of the first workpiece and a second side of the first workpiece;
forming an annular ridge surrounding the first bore on at least one of the first or second sides of the first workpiece;
forming a second bore in a second workpiece;
forming an annular recess surrounding the second bore;
placing the first workpiece in contact with the second workpiece such that the annular ridge is received in the annular recess; and
forming a hermetic seal between the first and second workpieces by deforming the annular ridge within the annular recess through application of compressive force to at least one of the first or second workpieces.

2. The method according to claim 1, wherein the second bore extends between first and second sides of the second workpiece.

3. The method according to claim 2, further comprising:
inserting a fastener through the first and second bores.

4. The method according to claim 3, wherein the fastener includes a rivet, and wherein deforming the annular ridge is performed during installation of the rivet.

5. The method according to claim 1, wherein the annular ridge, prior to deformation, comprises an apex and the annular recess comprises a planar surface.

6. The method according to claim 5, wherein the apex of the annular ridge is flattened against the planar surface of the annular recess after deformation.

7. The method according to claim 1, wherein first bore and the annular ridge are formed in a piercing process.

8. The method according to claim 7, wherein the first bore and the annular ridge are formed in a single step.

9. The method according to claim 1, wherein the first workpiece comprises a housing of a pressurized chamber of a torque converter.

10. The method according to claim 10, wherein the first and second bores are adapted to receive a rotating component of the torque converter.

11. The method according to claim 1, wherein the annular ridge protrudes from a planar main portion of the first workpiece between approximately 0.5 mm to 1.5 mm.

12. An assembly comprising:
a first workpiece having a first bore extending between a first side of the first workpiece and a second side of the first workpiece, and an annular ridge surrounding the first bore on at least one of the first or second sides of the first workpiece; and
a second workpiece having a second bore and an annular recess surrounding the second bore;
wherein the first workpiece and the second workpiece are arranged such that the annular ridge is received in the annular recess; and
wherein the annular ridge is deformed within the annular recess such that at least a portion of the annular ridge has a shape corresponding to the annular recess thereby forming a hermetic seal between the first and second workpieces.

13. The assembly according to claim 12, wherein the second bore extends between first and second sides of the second workpiece.

14. The assembly according to claim 13, further comprising a fastener inserted through the first and second bores.

15. The assembly according to claim 14, wherein the fastener includes a rivet, and wherein the annular ridge is deformed during installation of the rivet.

16. The assembly according to claim 12, wherein the first workpiece comprises a housing of a pressurized chamber of a torque converter.

17. The assembly according to claim 16, wherein the first and second bores are adapted to receive a rotating component of the torque converter.
